(19) United States
(12) Patent Application Publication
(10) Pub. No.: US 2016/0175698 A1
(43) Pub. Date: Jun. 23, 2016

(54) SYSTEM AND METHOD FOR DIRECTING A TARGETED OBJECT ON AN INTERACTIVE SURFACE TO PRODUCE A RESPONSE

(71) Applicant: Zheng Shi, Beijing (CN)

(72) Inventor: Zheng Shi, Beijing (CN)

(21) Appl. No.: 15/054,161

(22) Filed: Feb. 26, 2016

Related U.S. Application Data
(63) Continuation-in-part of application No. PCT/CN2014/085668, filed on Sep. 1, 2014.
Application No. PCT/CN2014/085668 is a continuation-in-part of application No. PCT/CN2014/084498, filed on Aug. 15, 2014.
Application No. PCT/CN2014/084498 is a continuation-in-part of application No. PCT/CN2014/079891, filed on Jun. 13, 2014.
Application No. PCT/CN2014/085668 is a continuation-in-part of application No. PCT/CN2014/080495, filed on Jun. 23, 2014.
Application No. PCT/CN2014/080495 is a continuation-in-part of application No. PCT/CN2014/079892, filed on Jun. 13, 2014.

(51) Int. Cl. A63F 3/00; H02J 5/00

(52) U.S. Cl. CPC A63F 3/00643; H02J 5/005

(57) ABSTRACT

The present invention discloses a system and method to direct one or more objects to produce an output when objects are placed on or near an interactive surface. The system includes a plurality of objects, each embedded with a unique identification code (UID) and an output device; an interactive surface configured to recognize the UID and location information of an object placed on or near the interactive surface; a processor operatively linked to the interactive surface and configured to execute a computer program encoding user-defined rules regarding the objects. Once the plurality of objects are placed on or near the interactive surface, the processor is configured to generate an output instruction for a first object based on the user-defined rules and the UID and location information of the objects, and direct the output device of the first object to produce the output in accordance with the instruction.

### CROSS-REFERENCE TO RELATED APPLICATION

This application is a continuation in part of International Patent Application No. PCT/CN2014/085668, entitled “System and Method for Directing a Targeted Object on an Interactive Surface to Produce a Response”, filed on Sep. 1, 2014, which is a continuation in part of International Patent Application No. PCT/CN2014/084498, entitled “System and Method for Directing a Moving Object on an Interactive Surface”, filed on August 15, 2014, which is a continuation in part of International Patent Application No. PCT/CN2014/079891, entitled “System and Method for Operating a Computer Program with Physical Objects”, filed on Jun. 13, 2014. The International Patent Application No. PCT/CN2014/085668 is also a continuation in part of International Patent Application No. PCT/CN2014/080495, entitled “System and Method to Recognize an Object's ID, Orientation and Location Relative to an Interactive Surface”, filed on Jun. 23, 2014, which is a continuation in part of International Patent Application No. PCT/CN2014/079892, entitled “System and Method for Identifying an Object's ID and Location Relative to an Interactive Surface”, filed on Jun. 13, 2014.

The entire disclosures of each of the above applications are incorporated herein by reference.

### TECHNICAL FIELD

The present invention relates to educational and recreational devices; and more particularly, to interactive surfaces for detecting the location and ID of specific objects placed on or near the surface.

### BACKGROUND

The abundance of inexpensive computer processors has greatly influenced recreational and educational games by enabling a high level of interactivity between the user and devices. For instance, many computerized games that enable a human player to play against a computerized opponent have already been developed. Typically, such computerized games provide a visual display of the game activity through an electronic display system to create a dynamic interactive multi-media environment. Unfortunately, such display lacks the three-dimensional nature that allows the physical interaction inherent in traditional board-based games. In addition, almost all computerized games are screen-based and require the players to interact with an electronic screen, whether it is on a laptop computer, a smart phone, or a tablet computer. As a result, users are increasingly exposed to screens from an early age when they use computerized interactive systems for either entertainment or education purpose.

On the other hand, traditional interactive systems may use one or more movable objects that users (especially young ones) find more “natural” and easier to interact with. For example, the conviviality and sensation offered by traditional board games where game pieces can be touched and manipulated is certainly advantageous. However, they often lack audio and/or visual interaction or other forms of sophisticated feedback that computerized games can offer.

Therefore, a method that can combine both computerized technology and physical play can effectively enhance a player's experience by allowing their physical actions to be interpreted by a computer system so as to provide real-time feedback to the player in the form of a multitude of sensorial accessories such as video and/or audio outputs.

The system in accordance to the embodiments of the present invention includes multiple physical objects such as cards, blocks or miniature figurines that could interact with a user through various feedback mediums such as LED lighting, speakers or vibrators. Such a system preferably does not contain a screen but makes use of an interactive surface that wirelessly communicates with objects placed on its surface so as to fully take advantage of the interactive power derived from computers.

In effect, the present invention provides a system and method that can effectively enhance the traditional playing objects such as cards and toy blocks by adding an interactive dimension to them. The playing objects can be wirelessly connected to computer systems which, in turn, can be connected to the internet/servers.

### SUMMARY OF THE INVENTION

The present invention discloses a system and method for directing one or more devices to produce a response once they are placed on or near an interactive surface.

In accordance with one embodiment of the present invention, the system includes a plurality of objects, an interactive surface, a processor, and an RF antenna that is operatively linked to the interactive surface. The interactive surface is able to recognize the location and UID of an object whenever the object is placed on the interactive surface. The objects of the present invention are each embedded with an RF antenna, an MCU which contains the object's unique identification code (UID), an output device to provide feedback to the user, and a power module to supply power to the electronic circuitry of the object.

The method of the abovementioned embodiment includes the steps of: placing one or more objects on or near the interactive surface; detecting the location and UID of the objects placed on or near the interactive surface by the said interactive surface; targeting the UID of one or more objects placed on or near the interactive board chosen by a computer program; transmitting an RF signal containing data pertaining to an output instruction by the processor via the interactive surface's computer RF antenna to the targeted object(s) placed on or near the interactive surface; receiving of the RF transmission by the targeted object(s) via the RF antenna; processing the data by the object's MCU; sending an output instruction by the MCU to the object's output device; providing feedback to the user via the output device.

In accordance with one embodiment of the present invention, power module comprises a second RF antenna for harvesting RF energy and an electronic circuitry for converting RF energy to DC energy.

In accordance with one embodiment of the present invention, the object can be a chip, a button, a token, a card, a figurine, or a block.

In accordance with one embodiment of the present invention, the output device can be a light, an acoustic device, or a vibration device.

Another embodiment of the present invention provides a system which uses multiple cards with printed symbols on top of them. This embodiment includes an interactive surface capable of detecting the presence as well as the unique ID of cards placed on or near its surface. The interactive surface further includes a computer program linked to a processor, a power source, an RF antenna, and an audio system. The interactive surface is configured to scan for cards placed on or near its surface. Furthermore, the computer program of the interactive surface is configured to include or have access to a word database.

Each card of the abovementioned embodiment can further include an MCU, an RF antenna, a power source, and one or more LED lights. The symbol printed on top of each game card can be a letter of the alphabet. Furthermore, a database connected to the processor assigns each card symbol a UID.

The method of the abovementioned embodiment is the following. The computer program broadcasts via the interactive surface's audio system a question relating to a letter, syllable or word that the user needs to answer by selecting certain cards to place on or near the interactive surface. For example, a broadcast may constitute the following questions: “Can you tell me what letter the word apple starts with?”, “Can you tell me how to write bed?” or “Do you know how to write red?” The audio output prompts the user to select some cards and place them on top of the interactive surface. Thereupon, the interactive surface detects the presence and the UID of any cards placed on or near its surface, and relays that information to the processor. Given that each UID is assigned to a language-related symbol, the processor also determines the type of letters (or other language-related symbol) the user has placed on top of the interactive surface by accessing a database. The processor's computer program is further configured to analyze whether the correct card or set of cards is placed on the interactive surface by the user. After determining whether the user's input is correct, the processor can proceed to generate instructions for each individual card placed in the broadcasting area and direct to provide output in the form of lighting the LED lights of the objects.

In accordance with one embodiment of the present invention, the processor is configured to direct the output device of an object to produce an output at a predetermined time.

### BRIEF DESCRIPTION OF THE DRAWINGS

FIG. 1 is an exemplary schematic diagram illustrating the system including figurines placed on top of an interactive surface in accordance with one embodiment of the present invention.

FIG. 2 is an exemplary schematic diagram illustrating the basic components of the interactive surface in accordance with one embodiment of the present invention.

FIG. 3 is an exemplary schematic diagram illustrating the basic component of the game figurines in accordance with one embodiment of the present invention.

FIG. 4 is an exemplary schematic diagram illustrating the system including cards, with a letter of the alphabet printed on each in accordance with one embodiment of the present invention.

FIG. 5 is an exemplary schematic diagram illustrating the card design in accordance with one embodiment of the present invention.

FIG. 6 is an exemplary schematic diagram illustrating the system including cards placed on top of a sheet and the interactive board in order to play the mathematics game Sudoku in accordance with one embodiment of the present invention.

FIG. 7 is an exemplary schematic diagram illustrating the system process flow in accordance with one embodiment of the present invention.

### DETAILED DESCRIPTION OF THE INVENTION

Reference will now be made in detail to various embodiments of the invention, examples of which are illustrated in the accompanying drawings. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

The present invention may be better understood and its numerous objects and advantages will become apparent to those skilled in the art by reference to the accompanying drawings.

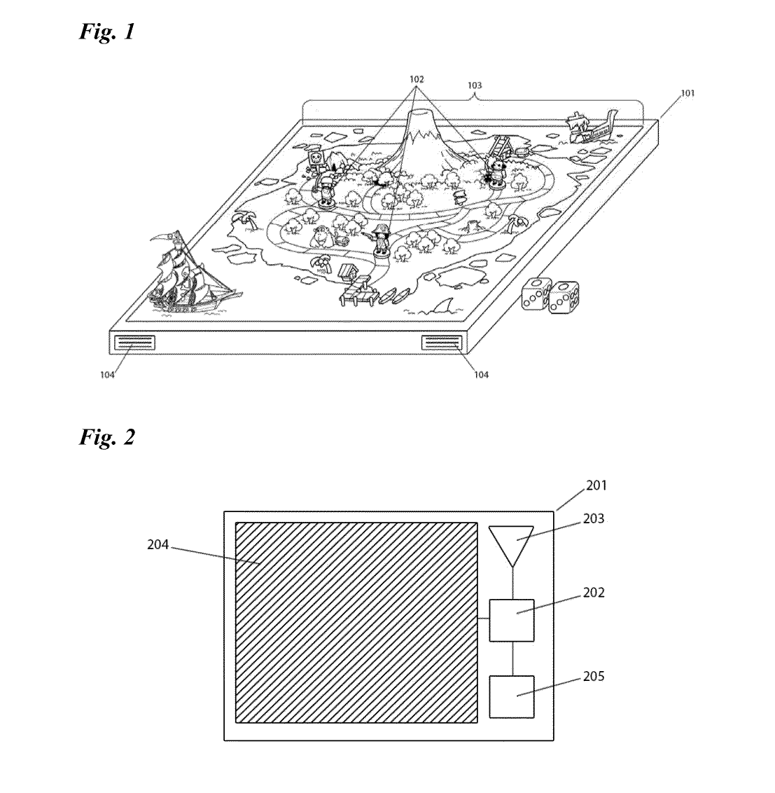

The embodiments of the present invention provide a system and method to direct one or more targeted objects to produce an output when placed on or near an interactive surface. FIG. 1 is an exemplary schematic diagram illustrating the system including figurines placed on top of an interactive surface in accordance with one embodiment of the present invention.

As shown in FIG. 1, the system includes an interactive surface 101 and a number of figurines 102. The interactive surface 101 further includes an operating surface area 103, wherein one or a set of sensors are affixed in such a manner that the location and UID of the figurines 102 placed in the area can be detected. The interactive surface 101 also has an audio system 104 affixed to it.

For the sake of illustration, both the system and method described in FIG. 1 makes use of an interactive surface 101 designed to create a 3D environment that depicts the popular “Pirate Island” theme wherein game figurines 102 can interact with the game board. The game board includes of a number of paths that intersect with each other. Players start from the island's wharf and take turns rolling a die to proceed down the paths with the objective to be the first to discover the treasure cove (which randomly changes location at the start of each new game). During the game progression, players' figurines 102 will have to confront a number of challenges in order to proceed. Crucially, figurines 102 are responsive to the areas in which they are located in. For example, placing a figurine 102 (e.g. the pirate captain) within the proximity of a designated area (e.g. the location of the treasure) may cause the figurine 102 or the interactive board 101 to provide real-time feedback to the player through various sensorial devices embedded within the figurine or the interactive surface, such as audio system 104. For example, a game figurine 102 may be embedded with a vibrator module so that whenever the figurine 102 is placed within a designated area, the figurine 102 will start vibrating to indicate to the player that the location is of special significance to this figurine 102.

FIG. 2 is an exemplary schematic diagram illustrating the basic components of the interactive surface described in FIG. 1 in accordance with one embodiment of the present invention. It should be noted that the shapes and dimensions of the electronic components described in FIG. 2 are made for illustration purposes only and are not in scale.

As shown in FIG. 2, the interactive surface 201 includes a computer system 202 (including both a processor unit and a memory unit), an RF antenna 203 operatively linked to the computer system 202, one or a set of sensors 204 operatively linked to the computer system 202, a central power source 205 to power the computer system 202, and other circuitry for the rest of the interactive surface's 201.

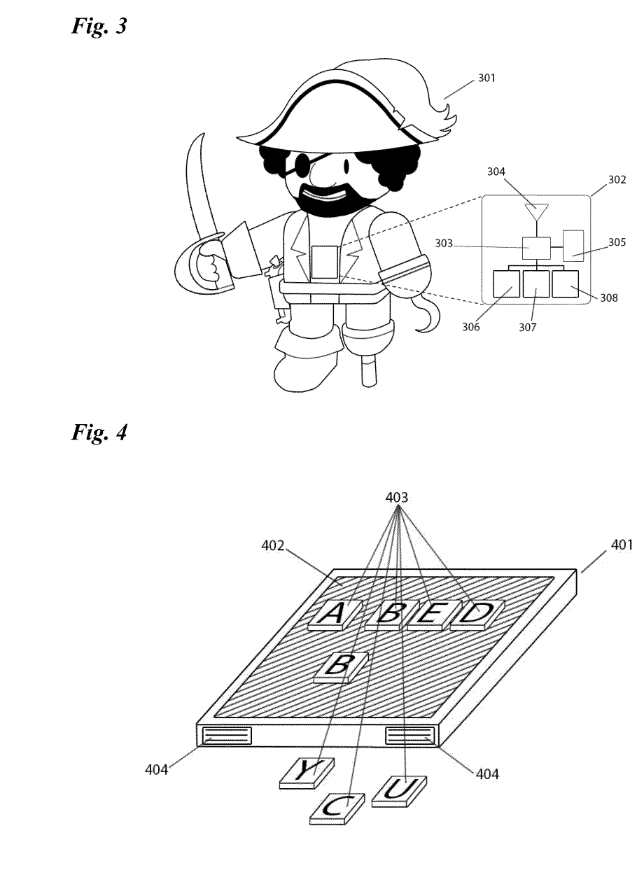

FIG. 3 is an exemplary schematic diagram illustrating the basic component of the game figurines depicted in FIG. 1. Again, it should be noted that the shapes and dimensions of the electronic components described in FIG. 3 are made for illustration purposes only and are not in scale.

The game figurine 301 includes an electronic module 302 embedded within it. The electronic module 302 includes an MCU 303 containing the UID of the figurine 301, an RF antenna 304 operatively linked to the MCU 303, a power source 305 operatively linked to the MCU 303, and output devices 306, 307, 308 that are also operatively linked to the MCU 303. The output device may be a number of different devices, such as two LED lights (one green LED 306, one red LED 307) and a vibrator module 308 in this particular embodiment.

Besides battery, power to the electronic module 302 in the game figurine 301 can be supplied through the use of a secondary RF antenna and an RF-DC energy harvesting device embedded in the electronic module 302. In this embodiment, the interactive surface powers the figurines 301 through RF waves, which the electronic module's 302 secondary RF antenna picks up and transmits to a RF-DC energy harvesting device to power the module and/or its battery.

The operation of the embodiment described in FIGS. 1, 2 and 3 is the following. Whenever a game figurine 102, 301 is placed on the interactive surface 101, 201, the interactive surface 101, 201 detects the ID of the figurine 102, 301 as well as its relative location on the interactive surface 101, 201 and transmits this information to the computer system 202. The processor of the computer system 202 is configured to process the information by executing a computer program that is operatively linked to the processor. The computer program is defined based on rules of the game and responsive to the movements of figurines 102, 301 relative to the operating surface area 103. Depending on the game rules and the location of a specific figurine 102, 301 (as well as other potential variables such as timing), the computer program may generate an out instruction for the figurine 102, 301 and direct the figurine 102, 301 to produce a feedback to the player by activating the targeted figurine's 102, 301 output device through RF communication between the interactive surface's 201 RF antenna 203 and the RF antenna 304 embedded in the figurine 102, 301. For example, a player's figurine 102, 301 is located at a crossroad on the game board. The computer program proceeds to ask the player a riddle that they must answer correctly in order to proceed. The player selects his answer by moving his figurine 102, 301 in one of the two directions (i.e. picking one of the two roads branching out). The interactive surface detects the new location of the figurine 102, 301 and relays this information back to the computer system 202. If the correct path is chosen, the processor of the computer system 202 directs the figurine 102, 301 to flash its green LED light 306 to indicate to the user that he has answered correctly. On the other hand, if the incorrect path is chosen, the processor directs the same figurine 102, 301 to flash its red LED light 307 (and a penalty would typically follow such as going back a number of cases). Another example of the figurine 102, 301 providing direct feedback to the user is to have the figurine's vibrator module 308 vibrate more vigorously as it approaches the location of the treasure.

FIG. 4 is an exemplary schematic diagram illustrating the system including cards, each with a letter of the alphabet printed on them in accordance with one embodiment of the present invention.

The embodiment depicted in FIG. 4 show the design of a spelling game. The interactive surface 401 includes: a processor (linked to a memory); an RF antenna operatively linked to the processor; and a central power source to power the interactive surface 401. The interactive surface 401 further includes an operating surface area 402 wherein one or a set of sensors are affixed in such a manner that the location and UID of cards 403 placed on top of the operating surface 402 can be determined by the processor. The interactive surface 401 also includes an audio system 404 affixed to it so as to provide both input and feedback to the user.

The system embodiment described above for the spelling game also has access to a word database (i.e., e-dictionary) and is configured to ask the user spelling-related questions.

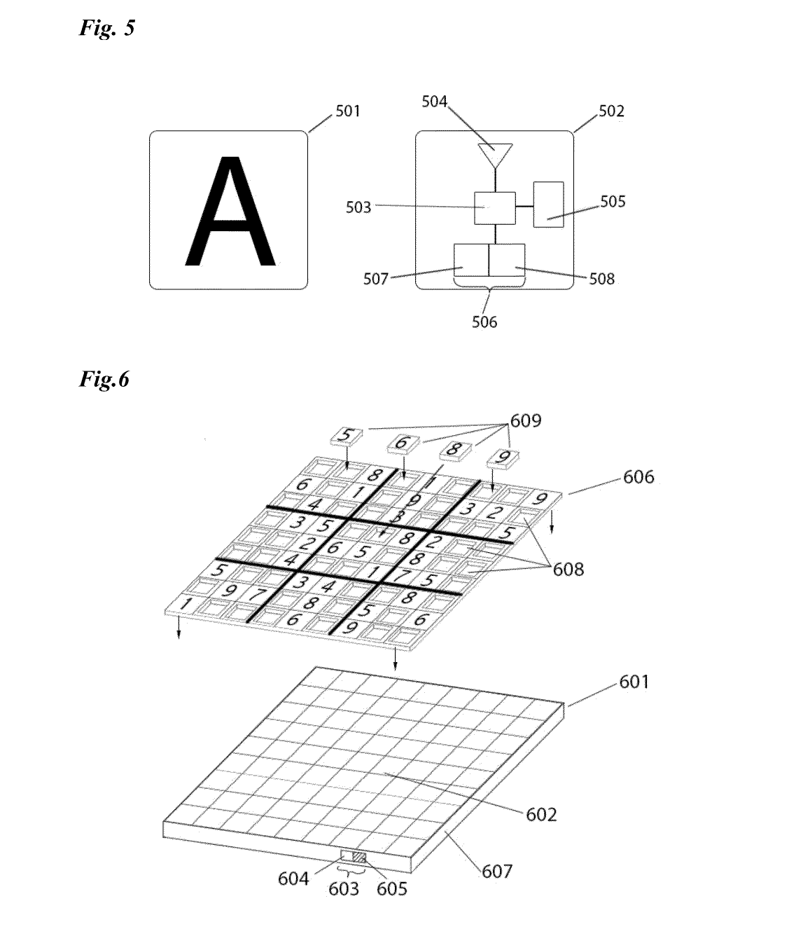

FIG. 5 is an exemplary schematic diagram illustrating the card for the spelling game embodiment described in FIG. 4 in accordance with one embodiment of the present invention. It should be noted that the shapes and dimensions of the electronic components described in FIG. 5 are made for illustration purposes only and are not in scale.

The left-side figure in FIG. 5 illustrates a card 501 as it appears to the naked eye. One can see that the letter A is printed on its surface. The right-side figure in FIG. 5 illustrates the specific electronic circuitry embedded in the card 502.

The card 501 includes an MCU 503 containing the UID of the card 501, an RF antenna 504 operatively linked to the MCU 503, a power source 505 operatively linked to the MCU 503, two LED lights 506 (one green LED 507 and one red LED 508) that are operatively linked to the MCU 503. Furthermore, in this embodiment, the computer program of the interactive surface 401 is configured to match each card UID to the letter it has been attributed to.

The method of the embodiment described in FIG. 4 and FIG. 5 involves configuring the computer program to broadcast to the user spelling-related questions via the audio system 404 of the interactive surface 401. For example, some of these questions could be “Do you know what letter the word apple starts with?” or “Do you know how to spell dog?” and so forth. These broadcasts will prompt the user to select a number of cards 403 and place them on top of the interactive surface's 401 operating area 402. In this particular embodiment, the computer program runs a timer in which the user must place all cards 403 corresponding to the correct answer before the time runs out. When the time runs out, the processor generates output instructions for all cards 403 depending on the games rules and whether the correct cards 403 have been placed on the interactive surface 401 (by determining the UID of each card 403 placed upon the operating surface area 402). Afterwards, the processor proceeds to instruct all correct cards to activate their green LED 507 (indicating a correct answer) and for all incorrect cards to activate their red LED 508 (indicating an incorrect answer) through wireless RF communication between the interactive surface's 501 RF antenna and the cards 503 RF antenna(s).

Similar to the embodiment described above, yet another form of feedback to the user includes having the LED lights 506 embedded in the cards 403 to light up in a sequential manner. In a typically design, only one LED light is required per card/UID. This design is particularly useful in helping the user to understand the order of the language symbols relative to one another. For example, the computer program broadcasts an audio recording through its speaker system 404 asking the user “how to spell the word bed”. This prompts the user to place three cards with the letters b, e, and d on top of the operating surface area 402. In this particular embodiment, the processor instructs the RF antenna of the interactive surface to transmit RF data containing separate instructions to all three cards 403 to light up their LED at differing times. First, the processor instructs the card 403 with the letter b to light up (preferably accompanied by an audio rendering of the letter's pronunciation by the interactive surface's 401 audio system 404), then it separately lights up the card with the letter e and then finally the card 403 with the letter d. In such a manner, the user is provided with a visual demonstration of the correct order of each letter within the word.

The particular embodiments described above provide an interactive game for young children whereby children can play with letter cards within a designated area. Such a game has clear educational merits as it allows children to experiment with letter cards and learn spelling in a fun and playful environment.

Although the abovementioned embodiments make use of language-related symbols, there are a large number of other options that can be implemented in the present invention. For example, virtually any language, both alphabet-based and non-alphabet-based, can be used for the cards.

Another embodiment provides a mathematics game which uses Arabic numerals (or other such as Chinese or Latin numerals) as the symbols printed on the surface of cards.

Another embodiment uses music notes as the symbols printed on the surface of each card.

Other card designs involve pictures instead of symbols. The pictures often used on flash cards such as animals, professionals, vehicles or the like are all viable options.

FIG. 6 is an exemplary schematic diagram illustrating the system including cards placed on top of a sheet and the interactive board in order to play the mathematics game Sudoku in accordance with one embodiment of the present invention.

In this embodiment, the system includes the combination of an interactive surface 601, a removable sheet 606, and multiple cards 609. Each card 609 has a number ranging from 1 to 9 printed on its surface, and the removable sheet 606 includes the Sudoku puzzle that a user must complete.

The system of the embodiment described in FIG. 6 includes the interactive board 601 with an operating surface are 602, and a base unit 607. As with the embodiments described in the previous figures, the operating surface area 602 includes a sensor system that is capable of detecting the presence, identity and orientation of one or more cards placed upon it, as well as the ID of sheet 606 placed upon its operating surface area 602. Again, as with the previous embodiments, the sensor system of the operating surface area 602 is electronically connected to a computer system 603 including both a processor 604 and a memory unit 605. As with all other embodiments, the processor 604 of the computer system 603 executes a computer program. In this embodiment, the computer program relates to a Sudoku game.

The embodiment in FIG. 6 further includes a sheet 606 with the typical 9*9 Sudoku grid printed upon it. As with all Sudoku games, some of the cells in the grid are already filled with numbers, and others are left blank. It is important to note that holes 608 are designed for those cells left blank in the grid. Cards 609, each with an Arabic numeral printed on them, are the last components in this embodiment. These cards 609 are designed to fit into the holes 608 in the sheet 606 so that they are in direct contact with the interactive surface's 601 operating surface area 602.

The design of the cards 609 is similar to the cards illustrated in FIG. 5 in that the electronic components are the same and the output device includes two LED lights (one green, the other red).

The general method of the present embodiment is the following. The user places the sheet 606 on top of the interactive surface's 601 operating surface area 602. The computer system 603, via the sensor(s) of the operating surface area 602, detects the presence of the sheet 606 and the processor identifies its ID (and thus the Sudoku game being played at that time). It is important to note that the orientation of the sheet is not important as the game can be played from any of the four sides of the interactive surface 601. Afterwards, the corresponding computer program for that particular Sudoku's grid is loaded and the user can proceed to solve the puzzle.

During the game, a user places various cards 609 through the holes 608 of the sheet 606 in order to solve the puzzle. Whenever the user places a card 609 on the operating surface area 602, the computer system 603, via the sensor(s) of the operating surface area 602, detects the location of card 609 as well as its unique ID. The processor 604 of the computer system 603 then deduces from the card's 609 ID information the Arabic numeral that has been assigned to that card 609 and generates output instructions for all cards 609 depending on the Sudoku game rules and whether or not the card has been correctly placed relative to that particular Sudoku grid. There are a large number of ways one could design how the game is played, but an elegant design is to requiring the user to place cards 609 in all the sheet's 606 holes 608 before a timer runs out.

Once the puzzle is completed, the procoessor proceeds to instruct all correct cards 609 to activate their green LED (indicating a correct answer) and for all incorrect cards to activate their red LED (indicating an incorrect answer). Accordingly, the cards 609 themselves provide direct feedback to the user when the puzzle is completed.

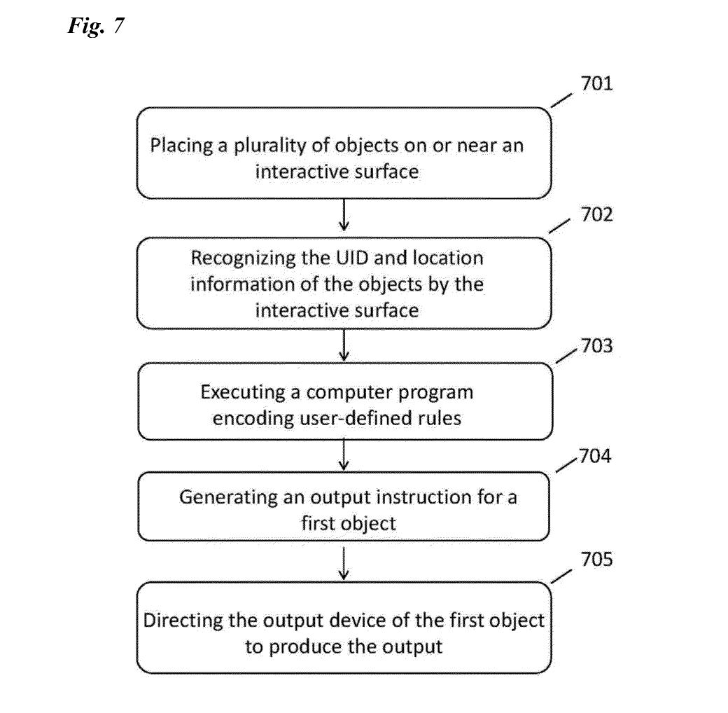

FIG. 7 is an exemplary schematic diagram illustrating the system process flow in accordance with one embodiment of the present invention.

As shown in FIG. 7, the method includes the following steps:

Step 701: placing a plurality of objects, each object embedded with a unique identification code (UID) and an output device, on or near an interactive surface. Each object may also include a power source.

Step 702: recognizing the UID and location information of the plurality of objects placed on or near the interactive surface. The interactive surface includes sensors that can recognize the UID and location information of any objected being placed on the interactive surface.

Step 703: executing a computer program encoding user-defined rules. The computer program can be executed either locally or remotely, while the user-defined rules are typically games rules, such as the rules for the “Pirate Island” game.

Step 704: generating an output instruction based on the user-defined rules and the location information of the plurality of objects on the interactive surface. Based on the objects on the interactive surface, and the user defined rules, an appropriate response is chosen by the processor.

Step 705: directing the output device of a first object to produce the output at a predetermined time. The predetermined time can be, for example, the time required for a user to answer a question in a spelling game.

In accordance with embodiments of the present invention, an interactive dimension is added to traditional playing objects such as cards, blocks and figurines so that users can with them through a variety of feedback mediums, such as LED lighting, speakers or vibrators.

1. A system for directing an object on an interactive surface to produce a response, comprising:
a plurality of objects, each object embedded with a unique identification code (UID) and an output device;
an interactive surface configured to recognize the UID and location information of an object placed on or near the interactive surface;
a processor operatively linked to the interactive surface and configured to execute a computer program encoding user-defined rules regarding the objects;
wherein, upon the plurality of objects being placed on or near the interactive surface, the processor is configured to generate an output instruction for a first object based on the user-defined rules and the UID and location information of the objects, and direct the output device of the first object to produce the output in accordance with the instruction.

2. The system of claim 1, wherein the first object is embedded with a first RF antenna and a micro-computer unit (MCU) operatively linked to the first RF antenna and the output device of the first object.

3. The system of claim 1, wherein the processor is configured to direct the output device embedded in the first object by RF communication between the interactive surface and the first RF antenna.

4. The system of claim 1, wherein the first object is embedded with a power source.

5. The system of claim 4, wherein the power source is a wireless power module comprising a second RF antenna for harvesting RF energy and an electronic circuitry for converting RF energy to DC energy.

6. The system of claim 1, wherein the output device is selected from a group consisting of a light, an acoustic device, and a vibration device.

7. The system of claim 1, wherein the first object is selected from a group comprising of a chip, a button, a token, a card, a figurine, and a block.

8. The system of claim 1, wherein the computer program is executed remotely.

9. The system of claim 1, wherein the processor is configured to direct the output device of a first object to produce an output at a predetermined time.

10. A method for directing an object on an interactive surface to produce a response, comprising:
placing a plurality of objects, each object embedded with a unique identification code (UID) and an output device, on or near an interactive surface;
recognizing the UID and location information of the plurality of objects placed on or near the interactive surface;
executing a computer program encoding user-defined rules;
generating an output instruction for a first object based on the user-defined rules and the UID and location information of the objects; and
directing the output device of the first object to produce the output in accordance with the instruction.

11. The method of claim 10, wherein the first object is embedded with a first RF antenna and a micro-computer unit (MCU) operatively linked to the first RF antenna and the output device of the first object.

12. The method of claim 10, further comprising directing the output device embedded in the first object by RF communication between the interactive surface and the first RF antenna.

13. The method of claim 10, wherein the first object is embedded with a power source.

14. The method of claim 13, wherein the power source is a wireless power module comprising a second RF antenna for harvesting RF energy and an electronic circuitry for converting RF energy to DC energy.

15. The method of claim 10, wherein the output device is selected from a group consisting of a light, an acoustic device, and a vibration device.

16. The method of claim 10, wherein the first object is selected from a group comprising of a chip, a button, a token, a card, a figurine, and a block.

17. The method of claim 10, further comprising, executing the computer program encoding the user-defined rules remotely.

18. The method of claim 10, further comprising, directing the output device of the first object to produce the output at a predetermined time.
